(19) United States
(12) Patent Application Publication
(10) Pub. No.: US 2010/0188978 A1
(43) Pub. Date: Jul. 29, 2010

(54) METHOD FOR TIME DELAYING DIGITAL CONTENT FLOWS, CORRESPONDING DEVICE, AND COMPUTER PROGRAM PRODUCT

(75) Inventors: Philippe Coent, Saint Didier (FR); Yves Le Hervet, Thorigne-Fouillard (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: TDF, Montrouge Cedex (FR)

(21) Appl. No.: 12/445,014

(22) PCT Filed: Oct. 8, 2007
(86) PCT No.: PCT/EP2007/060662

§ 371 Date: Apr. 7, 2010

(30) Foreign Application Priority Data
Oct. 10, 2006 (FR) 0608882

(51) Int. Cl. H04L 12/24

(52) U.S. Cl. 370/235

(57) ABSTRACT

A method is provided for delaying a digital flow broadcast. The digital flow is carried by a plurality of datagrams, each including a first network level flow destination address. The method includes capturing and continuously recording the broadcast datagrams in a temporary recording space, creating a recorded flow. The datagrams of the recorded flow are continuously retransmitted after a preset length of time.

### CROSS-REFERENCE TO RELATED APPLICATIONS

This Application is a Section 371 National Stage Application of International Application No. PCT/EP2007/060662, filed Oct. 8, 2007 and published as WO 2008/043738 on Apr. 17, 2008, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to the field of digital content broadcasting on communication networks. Digital content is taken to mean any type of multimedia content such as video, audio, data.

The present disclosure relates more particularly to a method for delaying the broadcasting of digital content flows, also known as “digital flows”. A digital flow of this kind is carried, on a network, by a plurality of datagrams (also known as packets).

There are numerous means in existence for broadcasting digital contents, including techniques based on standards issued by the Digital Video Broadcast (DVB) consortia. Other broadcasting techniques may also be employed by using networks, for example, that operate on the “Internet Protocol” (IP).

Whatever means is used, the content broadcaster (communication operator, television service, etc.,) is able to make use of delaying the flow transmission by a given time. This kind of situation arises for example when broadcasting political or sporting events which, for security reasons, must not be broadcast live. A broadcast is deemed to be live when no deliberate action is taken to offset the occurrence of an event and the perception thereof by a user through his flow retrieval device.

In fact, depending on the type of broadcasting equipment used, a variable time lag may occur between the occurrence of an event and the perception thereof. Said time lag is however not deliberate, since it may for example be due to propagation time in the air. Deliberate time lags however are generally applied at the head-ends. A head-end may be taken to be a master broadcasting unit, namely, for example, a dish for transmitting to a broadcasting satellite. The content supplier or a service provider used by the content supplier has a broadcasting dish of this kind. Said dish transmits the content bundles out to the satellite responsible for broadcasting to the dishes of the supplier's customers.

### BACKGROUND OF THE DISCLOSURE

Prior art time lag generation techniques are for the most part applied at the head-ends, based on a continuous time lag in the flow. The techniques applied involve storing, for a given time, the content to be delayed, and then transmitting it with a given time lag.

For example, where a television program is broadcast, the data constituting the flow is delayed: the voices, animated (video) images and data are stored in the form of independent revolving files before they are assembled. Depending on the real-time flow assembly methods, the voices, animated images and data are stalled in time before being mixed and encoded so that the delayed content can be produced and transmitted.

Other techniques may also be employed, such as for example a time lag of the assembled flow. In this event, the frames composing the flow are recorded and broadcast with the required time lag on the channel, after having been re-encoded as a function of the intended receiver equipment.

One drawback with these prior art techniques stems from the heavy dependence of the time lag techniques relative to digital flow broadcasting formats. Indeed, the technical breakdown of this time lag functionality as it exists on current platforms is based in general on the use of Video on Demand (VOD) servers. The time lag may also be integrated with software or hardware encoding solutions. These solutions depend heavily on the encapsulation format and/or on the digital format used. For example, moving from MPEG-2 video to MPEG-4 video content management generally involves the installation of new equipment. The time lag has therefore to be implemented on two different pieces of equipment.

Other solutions also use the system of capturing flows in order to play them back afterwards. This kind of implementation means, however, having to wait for a recording to end before being able to play back/re-transmit the audio/video flow. The duration of the time lag cannot therefore be freely defined, since it is necessary to wait for the flow recording to end in order to be able to transmit it with a time lag.

### SUMMARY

An aspect of the disclosure relates to a method for delaying the broadcast of a digital flow, said digital flow being carried by a plurality of datagrams each comprising a first network level flow destination address.

According to an embodiment of the invention, such a method comprises the following steps:
capturing and continuously recording said broadcast datagrams in a temporary recording space, creating a recorded flow;
continuously retransmitting said datagrams of said recorded flow after a preset period of time.

The digital flow is thus retransmitted, after a given period of time, without any change being made to the flow content per se. There is then no need for complex application processing involving processing the flow before it is broadcast anew with a given delay, as is the case with prior art techniques.

According to one original feature, said delaying method comprises:
a step of calculating a duration of said recorded flow in said temporary recording space; and in that
said continuous retransmission of said datagrams of said recorded flow starts when said duration of said recorded flow reaches a preset time value.

The receive characteristics (maintenance of original throughput and inter-packet delay) are thus best applied, the retransmitted packets contain the same data as those not delayed so long as the number of recorded packets matches, as a function of the flow receive characteristics, the given time lag.

According to one particular embodiment, said delaying method further comprises a step for the continuous deletion from said temporary recording space of said pre-recorded retransmitted datagrams.

It is not therefore necessary to have an unlimited amount of temporary recording space. Indeed the datagrams are deleted as they are transmitted. For example, for a preset delay time of 15 minutes and a datagram transmission frequency of 1000 per second with a weight of 32 bytes of flow data per datagram only 15*60*1000*32=28800000 bytes (i.e. about 28 MB) will be necessary for the flow time lag. Moreover, the processing actions required to delete a datagram from the temporary storage space do not require a great deal of computing capacity. Said method does not therefore require the setting up of bulky computer architectures.

According to one particular feature, said datagrams are retransmitted with a second network level flow destination address different from said first flow destination address.

The network level address (and therefore the destination IP address) is therefore different from the initial “multicast” destination address. The digital flow is therefore retransmitted using a different broadcasting address from that used for the initial broadcast. As a consequence, the digital flow can be received in two different modes: in real-time with no time lag or with a time lag. In this embodiment, a user viewing a television program is thus able to go away for a given length of time, for example 15 minutes, and then change channels in order to continue viewing the program without having to involve any equipment other than his digital receiver remote control.

According to an original mode of implementation, said method comprises a step of changing said preset time value as a function of a least one preset digital flow receive indicator.

The time lag value can thus be varied as a function of the conditions for receiving the digital flow. In this complementary implementation, the flow time lag can for example be extended if the conditions for receiving said flow are not good in order for example to allow the user to receive the digital flow in better conditions than if he had viewed it with no time lag.

According to one particular embodiment, said datagrams are UDP/IP datagrams.

An aspect of the invention also relates to a device for delaying a digital flow broadcast, said digital flow being carried by a plurality of datagrams each comprising a first network level flow destination address.

According to an embodiment of the invention such a device comprises:
means for capturing and continuously recording said broadcast datagrams in a temporary recording space, creating a recorded flow;
means for the continuous retransmission of said datagrams of said recorded flow after a preset period of time.

An inventive device of this kind may comprise in general terms means for implementing steps in the inventive delaying method.

In a particular embodiment, said delaying device is implemented on a broadcast head-end.

In a particular embodiment, said delaying device is implemented on a digital flow retrieval terminal.

An aspect of the invention also relates to computer program products that can be downloaded from a communications network and/or stored on a medium that can be read by computer and/or run by a microprocessor.

According to an embodiment of the invention such computer program products comprise program code instructions for implementing the previously described delaying method.

### BRIEF DESCRIPTION OF THE DRAWINGS

Other characteristics and advantages of will become clearer from reading the following description of one preferential embodiment, given as a straightforward illustrative example and non-restrictively, and the appended drawings, among which:

FIG. 1 shows a block diagram illustrating the digital flow broadcast processing string;

FIG. 2 shows an implementation of the inventive delaying method upstream of the encoding of the flows in the processing string shown in FIG. 1, according to an example embodiment;

FIG. 3 shows an implementation of the inventive delaying method downstream of the encoding of the flows in the processing string shown in FIG. 1, according to an example embodiment;

FIG. 4 shows an implementation of the inventive delaying method on a terminal unit, according to an example embodiment;

FIG. 5 shows an implementation of the inventive delaying method on a unit of a local domestic or company network, according to an example embodiment;

FIG. 6 describes succinctly a hardware architecture of a device implementing the inventive delaying method, according to an example embodiment;

FIG. 7 describes the inventive delaying method, according to an example embodiment.

### DETAILED DESCRIPTION OF ILLUSTRATIVE EMBODIMENTS

### 1. Review of an Inventive Principle

An embodiment of the invention therefore sets out to provide a flow time lag irrespective of the digital flow format. This independence with respect to the flow format is made possible by the invention through the use of a temporary storage of datagrams (also known as packets). Thus, unlike prior art techniques, an embodiment of the invention does not seek to store the flow, but the data used to carry said flow when it is broadcast. This inventive technique runs counter to prior art techniques.

The general principle of an embodiment of the invention is based on the temporary recording of flow transport data. For example, after being encoded, the flow data is transmitted through a communications network. For the purposes of this transmission, the flow is generally cut up into datagrams (or packets) which are then transmitted to destination equipment.

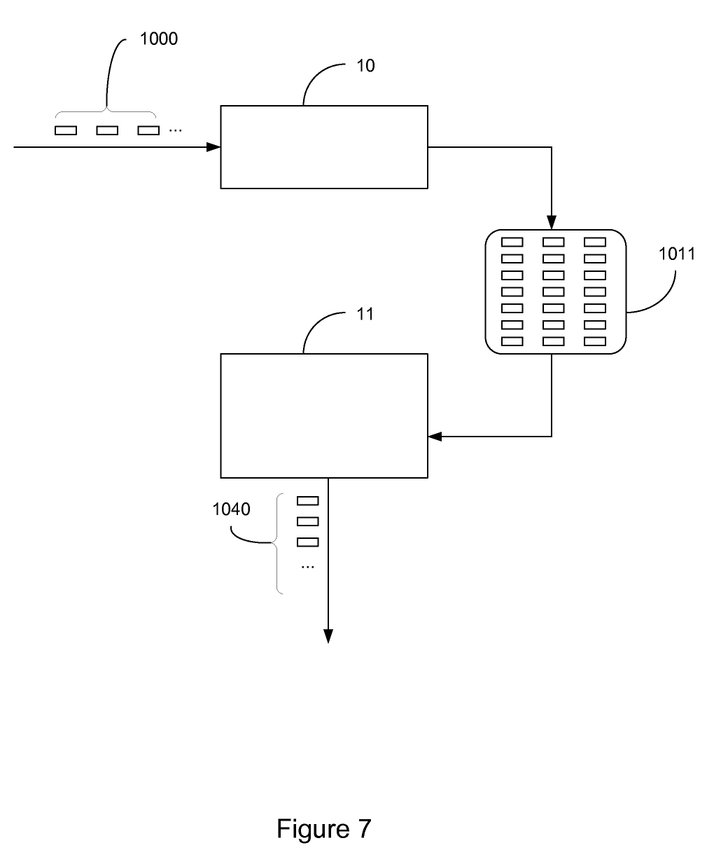

An embodiment of the invention allows a time lag in one or more digitized audiovisual sources (audio, video and/or data) carried via protocols that use the network level reception address principle (for example the User Datagram Protocol (UDP/IP). The time lag comprises at least two phases (FIG. 7):
capturing and storing (10) in a space provided to this end (1011) information flowing on the network in the form of packets (datagrams) 1000;
retransmitting (11) information in the form of packets 1040 possibly with a different destination address after a time delay has been applied.

The capture phase does not stop to make room for the retransmission phase.

An embodiment of the invention thereby offers, to a network operator or to a service provider, a time lag solution irrespective of the digital flow format, since an embodiment of the invention only processes transport datagrams.

Since the solution is based on capturing datagrams that are available on the network, the data part of the packets is not changed, and therefore the type and format of said data, audio video, raw data, MPEG-2 or MPEG-4 for example in respect of video, is of little importance. An embodiment of the invention can therefore be used in support of any type of content.

Likewise, the flow encapsulation format is transparent for an embodiment of the invention. It is for example quite conceivable to use an embodiment of the invention to delay a channel multiplex carried in the MPEG-2 TS encapsulation format itself transported on an IP network.

An embodiment of the invention can therefore be used to apply a time lag to contents in whatever format they may be, insofar as an embodiment of the invention operates only at transport and network level.

An example implementation basically requires small amounts of Processor resource and a storage capacity (this capacity is directly proportionate to the maximum applicable time delay duration).

The particular instance will now be shown of an implementation of the method for delaying the broadcast of a digital flow applied to an IP network using the UDP protocol. It is clear however that the invention is not restricted to this particular use, but may also be implemented in many other fields, and particularly in any type of broadcasting network that operates on the basis of carrying data in the form of datagrams and more generally in all situations where the advantages secured by the invention are worthwhile.

### 2. Description of One Embodiment.

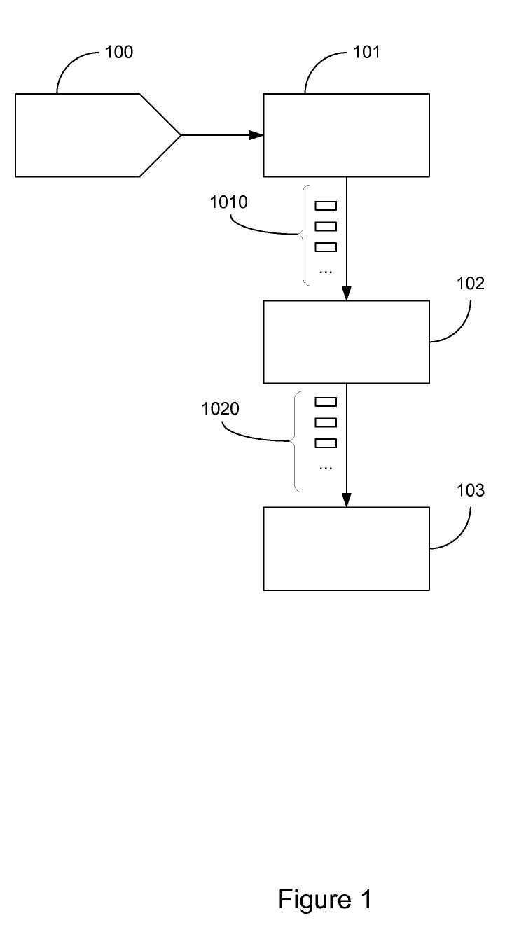

This embodiment shows the implementation of the delaying method in the context of a head-end platform for mobile television or digital domestic television on an IP (IPTV) network, the audiovisual contents are generally delivered in accordance with the following processing string (and as shown in FIG. 1):
capturing (101) digital or analogue signals 100 and transmitting in the form of packets 1010;
encoding or transcoding (102) the source signal 100 so that it is adapted to the broadcast mode;
providing the signal (103) via a “streaming” server to which the encoding device 10 transmits its information in the form of packets 1020 and to which the terminals are able to be connected.

This string can thus be used to offer a terminal-adapted “Live” television service, the adaptation being achieved mainly in the “(Trans)coding 102” block. This same time-lagged service can be offered in a plurality of ways.

According to an embodiment of the invention, UDP/IP packet time delay is used. This presupposes that the different elements constituting the string described communicate with each other via UDP/IP connections for broadcasting the content.

This delay block, which implements the time delay method, may be inserted into the string at a plurality of points, either upstream from the encoding or downstream. The choice of insertion depends on the overall platform architecture.

This block can be used to delay “unit” flows (the term unit is associated with an audiovisual service or TV channel, in other words a video component and one or more audio components) and multiplex flows (in other words a set of audiovisual services).

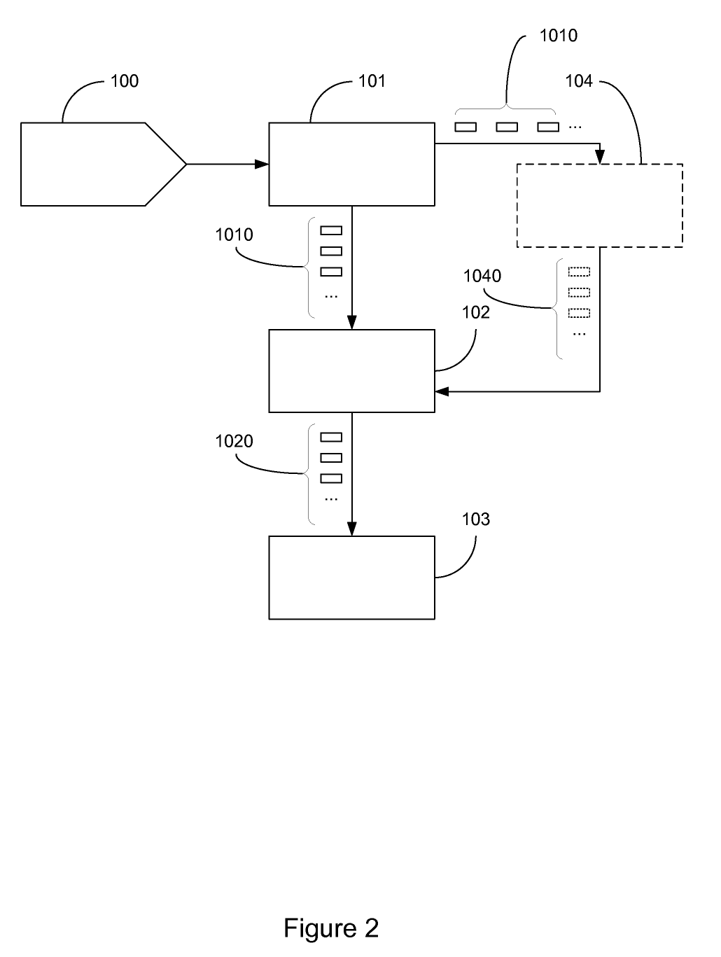

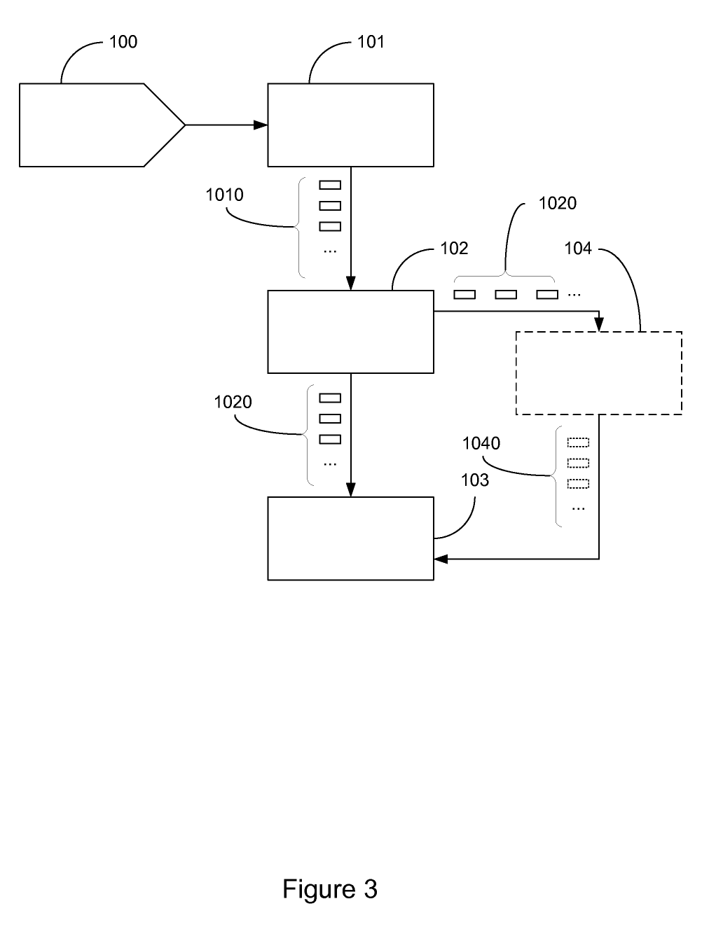

The two following diagrams (FIG. 2 and FIG. 3) in connection with the diagram in FIG. 1, show two instances of an embodiment of the invention (“Time Delay” block) being implemented on a head-end.

In a first alternative of this embodiment (FIG. 2), the inventive delaying method is implemented (104) upstream of the flow encoding. The delay is thus applied as soon as the capture (101) of the signal 100 has taken place. The delayed packets 1040 are transmitted to the transcoding device 102. Such an implementation allows a flow to be delayed whatever its subsequent broadcast mode. Indeed, the flow is delayed at the start of the string and retransmitted at the end of a given time which allows the transcoding unit 102 to encode the delayed flow towards different streaming servers 103 with the same time lag however many destination streaming servers there are.

In a second alternative of this embodiment (FIG. 3), the device implementing the time shifting method (104) is located downstream from the encoding device (102). The packets 1020 therefore also contain a digital flow, offset in time, which makes it possible not to have to re-encode the initial flow several times. In this embodiment, the real-time flow (coming from the transit of the packets 1020) and the delayed flow (by means of the packets 1040) are made available to a user on the streaming server.

In another alternative, the inventive method (104) may, in addition to the time lag, make a change to the destination address of the delayed datagrams. It is thus possible to transmit one and the same flow on two different channels: a main channel broadcasting the real-time flow and a secondary channel receiving the delayed flow. These two channels have different destination addresses, which makes switching from one to the other more straightforward both in application terms and in terms of use for an end user.

Indeed, changing the destination address, even if it is not mandatory, allows flow retrieving customer applications to change the flow for retrieval in a simplified way; they have merely to change the destination address of the packets transmitted. Clearly, address change is taken to mean changing both the address as such or the port for this IP address.

### 3. Other Optional Characteristics and Advantages

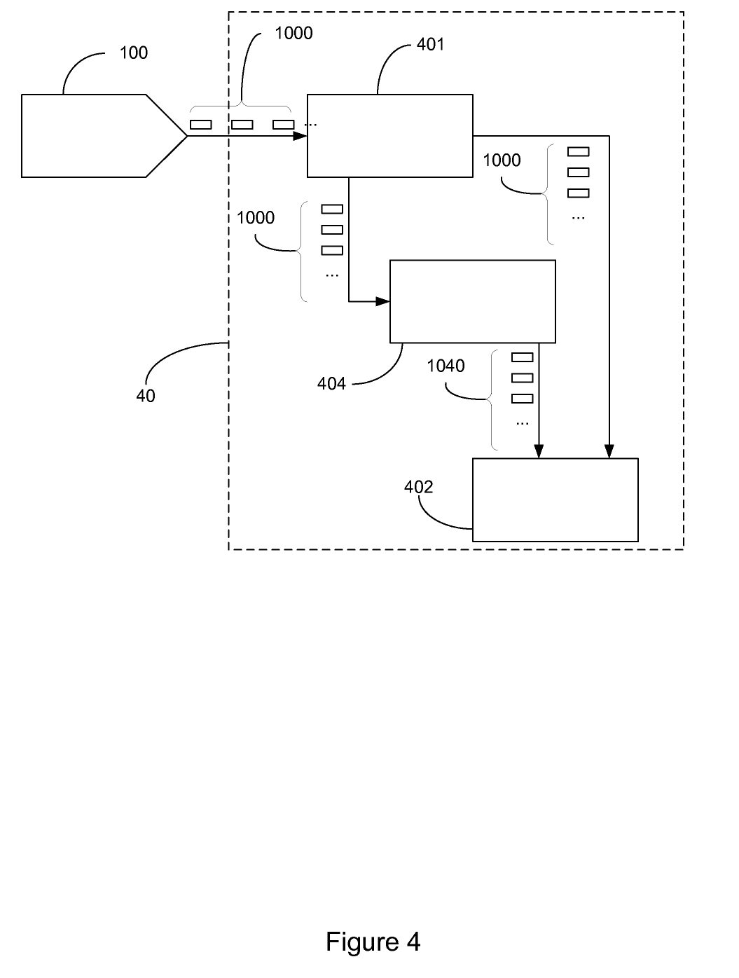

One embodiment of the invention is shown in relation to FIG. 4 in the context of an implementation on a digital television receiver (mobile or fixed). The delaying method then creates a set of additional flows (consisting of one or more audiovisual services (audio, video and/or data)).

A receiving terminal (40) is connected to a digital flow broadcasting network. Such a flow (100) is routed in the form of datagrams (packets) 1000 to a receiving device 401 located in the terminal 40. This receiving device transfers the datagrams 1000 to the display/encoding device 402 for the digital flow to be retrieved. It also transmits the datagrams 1000 to the device implementing the inventive delaying method 404. The implementation of the delaying method is accompanied by a change of destination address, particularly the destination port.

Thus, in this embodiment, the flow broadcaster does not encumber the broadcasting network with two identical flows and the user still has the time lag at his disposal. Huge bandwidth savings are therefore made on the broadcasting network.

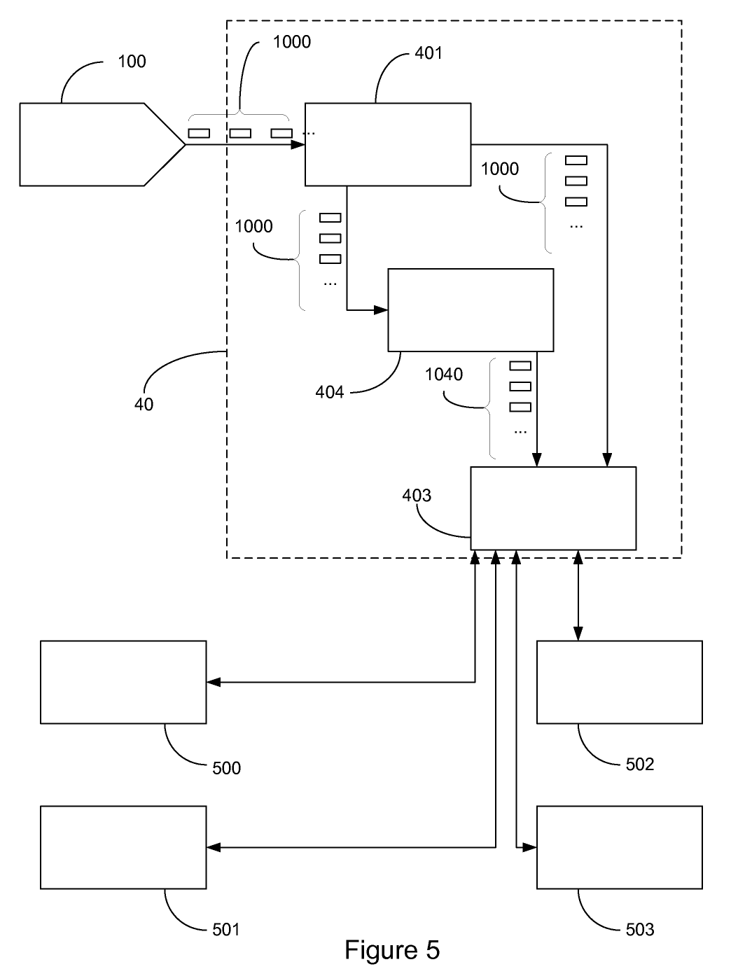

In the context of installing an embodiment of the invention on network equipment in a private home or in a company (modem/router “Box”, shown in relation to FIG. 5), the inventive method creates a set of additional flows (consisting of one or more audiovisual services (audio, video and/or data)). The initial service provider does not therefore encumber the network with additional flows offset in time, nor does the user use his decreasing bandwidth to access a same type service in VOD.

A receiving terminal (40) is connected to a digital flow broadcasting network. Such a flow (100) is routed in the form of datagrams (packets) 1000 to a receiving device 401 located in the terminal 40. This receiving device transfers the datagrams 1000 to the providing device 403 for the digital flow to be retrieved. It also transmits the datagrams 1000 to the device implementing the inventive delaying method 404. Implementation of the delaying method is accompanied by a change in the destination address.

In a complementary embodiment independent of the equipment implementing the method, it is possible to vary the time lag value as a function of the conditions for receiving the digital flow. In said complementary embodiment, it is for example possible to extend the flow time lag if the conditions for receiving said flow are not good in order for example to allow the user to receive the digital flow in better conditions than if he had viewed it with no time lag, in real-time.

In a complementary, more head-end oriented embodiment, the method can be used to deliver on-demand content supply functions by retransmitting the recorded content with a delay chosen by a given user or a group of users.

In a complementary more head-end oriented embodiment, the broadcasting of meta-data on IP according to this method will make it possible to create a backup data server in carousel mode at very low cost whatever protocols are used such as for example an Electronic Service Guide (ESG) server using the File Delivery over Unidirectional Transport (FLUTE) protocol on a Digital Video Broadcast Handheld (DVB-H) head-end.

It should also be noted that it is possible to cascade the method so as to deliver different time delays, this solution allowing storage capacity to be optimized; indeed if we take the flow generation example of two delayed flows, one of 30 minutes, the other 60 minutes, it is preferable to “store” twice 30 minutes than once 1 hour and once 30 minutes.

### 4. Simplified Architecture of the Inventive Delaying Device

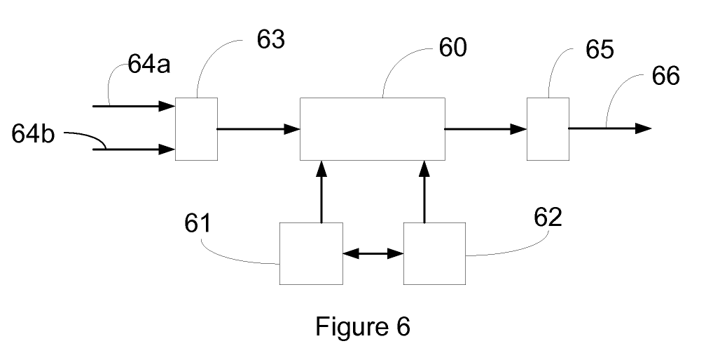

A simplified architecture of an inventive delaying device is shown in relation to FIG. 6.

It comprises a memory 61, and a processing unit 60 equipped with a microprocessor, which is controlled by a computer program (or application) 62. The processing unit 60 receives an input, via a network input interface module 63:
sets of datagrams coming from the broadcasting network 64a;
configuration parameters 34b.

This information is processed by the microprocessor, according to the program instructions 62, in order:
to transmit the broadcasting datagrams of the digital flows 66 obtained according to the given parameters;

These packets are transmitted via a network output interface module 65 to the devices responsible for them.

Although the present disclosure has been described with reference to one or more examples, workers skilled in the art will recognize that changes may be made in form and detail without departing from the scope of the disclosure and/or the appended claims.

1. A method for delaying a digital flow broadcast, said digital flow being carried by a plurality of datagrams, each comprising a first network level flow destination address, wherein the method comprises the following steps:
capturing and continuously recording said broadcast datagrams in a temporary recording space, creating a recorded flow;
changing a preset time value as a function of a least one preset digital flow receive indicator; continuously retransmitting said datagrams of said recorded flow after a length of time defined by said preset time value.

2. The method for delaying a digital flow broadcast as claimed in claim 1, wherein the method comprises:
a step of computing a duration of said recorded flow in said temporary recording space; and
said continuous retransmission of said datagrams of said recorded flow starts when said duration of said recorded flow reaches said preset time value.

3. The method for delaying as claimed in claim 1, wherein the method further comprises continuously deleting said recorded re-transmitted datagrams from said temporary recording space.

4. The method for delaying as claimed in claim 1, wherein said datagrams are retransmitted with a second network level flow destination address different from said first flow destination address.

5. The method for delaying as claimed in claim 1, wherein said datagrams are UDP/IP datagrams.

6. A device for time delaying a digital flow broadcast, said digital flow being carried by a plurality of datagrams, each comprising a first network level flow destination address, wherein the device comprises:
means for capturing and continuously recording said broadcast datagrams in a temporary recording space, creating a recorded flow;
means for determining a retransmission delay time value as a function of a least one preset indicator of conditions for receiving digital flow;
means for continuously retransmitting said datagrams of said recorded flow after a period of time defined by said preset time value.

7. The device of claim 6, wherein the device is implemented on a broadcast head-end.

8. The device of claim 6, wherein the device is implemented on a digital flow retrieval terminal.

9. A computer program product stored on a medium that can be read by computer and/or run by a microprocessor, wherein the product comprises program code instructions for performing a method for delaying a digital flow broadcast, said digital flow being carried by a plurality of datagrams, each comprising a first network level flow destination address, when the instructions are operated on a computer, wherein the method comprises:
capturing and continuously recording said broadcast datagrams in a temporary recording space, creating a recorded flow;
changing a preset time value as a function of a least one preset digital flow receive indicator;
continuously retransmitting said datagrams of said recorded flow after a length of time defined by said preset time value.
